(19) United States
(12) Patent Application Publication
(10) Pub. No.: US 2011/0083876 A1
(43) Pub. Date: Apr. 14, 2011

(54) CABLE

(75) Inventor: MING-KE CHEN, Shenzhen City (CN)

(73) Assignees: HONG FU JIN PRECISION INDUSTRY (ShenZhen) CO., LTD., Shenzhen City (TW); HON HAI PRECISION INDUSTRY CO., LTD., Tu-cheng (TW)

(21) Appl. No.: 12/625,574

(22) Filed: Nov. 25, 2009

(30) Foreign Application Priority Data
Oct. 8, 2009 (CN) 200910308112.2

(51) Int. Cl. H01B 7/00

(52) U.S. Cl. 174/113 R

(57) ABSTRACT

A cable includes several metal leads and a metal wire set adjacent to the metal leads. Each metal lead is spaced with the metal wire by flexible insulating material. The metal wire can be deformed without automatic restoring.

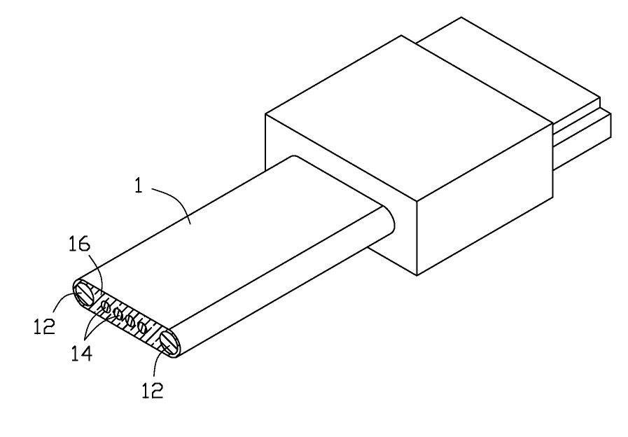

### BACKGROUND

1. Technical Field

The present disclosure relates to a cable applied in an electronic device.

2. Description of Related Art

With the development of electronic technology, the functions of electronic devices, such as computers, servers, and so on, are ever expanding, and consequently, there are more internal components, which are more densely arranged. Therefore the space between every two adjacent internal components in an electronic device is decreasing, and it is more difficult to arrange cables in the electronic device.

Ordinary cables applied in electronic devices include several metal leads which are covered with insulating material. Conventionally, the insulating material is made of flexible plastic, which is resilient and results in not being able to bend cable to specific shapes that will be maintained thus making it difficult to accurately route the cables. Not being able to accurately route the cables limits their application in electronic devices. Specifically, if the cables are not accurately routed in compact electronic devices, heat dissipation may be poor and damage to the electronic devices may ensue.

### BRIEF DESCRIPTION OF THE DRAWING

The drawing is a schematic, isometric view of an exemplary embodiment of a cable.

### DETAILED DESCRIPTION

Referring to the drawing, an exemplary embodiment of a cable 1 includes four metal leads 14, and two metal wires 12 set at opposite sides of the metal leads 14 and in parallel with the metal leads 14. The metal leads 14 and the metal wires are spaced by insulating material 16, the insulating material 16 is flexible insulating material, such as polyvinylchloride.

The metal wires 12 are made of one of copper, iron, and aluminum, or an alloy thereof. The rigidity of the metal wires 12 is greater than the rigidity of the insulating material 16, and the metal wires 12 can be deformed into different shapes but are not resilient. In other words the wires 12 will be flexible enough to be shaped as needed and at the same time stiff enough to maintain the shapes. A cross section of each of the metal wires 12 is circular, a diameter range of each of the metal wires 12 is about 18 American wire gauge (AWG) to 24 AWG.

In use, the cable 1 can be flexed and deformed because the metal wires 12 are attached to the metal leads 14 through the insulating material 16. However, the metal wires 12 cannot be broken easily when deformed because the toughness of the metal wires 12 is great and the cross section of each of the metal wires 12 is circular.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A cable, comprising:
a plurality of metal leads; and
at least one metal wire arranged adjacent to the metal leads, wherein each of the at least one metal wire is spaced from the plurality of metal leads by flexible insulating material, and the at least one metal wire is operable to be deformed with the shape formed being maintained.

2. The cable of claim 1, wherein the at least one metal wire is made of one material selected from the group consisting of cuprum, iron, aluminum, and alloy of the cuprum, iron, and aluminum.

3. The cable of claim 1, wherein the at least one metal wire is in parallel with the plurality of metal leads.

4. The cable of claim 1, wherein a cross section of each of the at least one metal wire is circular.

5. The cable of claim 4, wherein a diameter range of each of the at least one metal wire is about 18 American wire gauge (AWG) to 24 AWG.

6. The cable of claim 1, wherein the number of the at least one metal wire is two.

7. The cable of claim 6, wherein the two metal wires are separately arranged at opposite sides of the plurality of metal leads.
